(19) United States
(12) Patent Application Publication
(10) Pub. No.: US 2020/0251778 A1
(43) Pub. Date: Aug. 6, 2020

(54) ELECTROLYTE FOR LITHIUM SECONDARY BATTERY AND LITHIUM SECONDARY BATTERY COMPRISING SAME

(71) Applicant: SAMSUNG SDI CO., LTD., Yongin-si, Gyeonggi-do (KR)

(72) Inventors: Hyunbong CHOI, Yongin-si, Gyeonggi-do (KR); Aeran KIM, Yongin-si, Gyeonggi-do (KR); Hyejin PARK, Yongin-si, Gyeonggi-do (KR); Woocheol SHIN, Yongin-si, Gyeonggi-do (KR); Jinhyeok LIM, Yongin-si, Gyeonggi-do (KR)

(21) Appl. No.: 16/636,114

(22) PCT Filed: Jul. 4, 2018
(86) PCT No.: PCT/KR2018/006656

§ 371 Date: Feb. 3, 2020

(30) Foreign Application Priority Data
Aug. 3, 2017 (KR) 10-2017-0098304

(51) Int. Cl. H01M 10/0567; H01M 10/0525; H01M 10/0568; H01M 4/587; H01M 10/0569; C07F 9/146

(52) U.S. Cl. CPC H01M 10/0567; H01M 10/0525; H01M 10/0568; H01M 2004/027; H01M 10/0569; C07F 9/146; H01M 2300/0025; H01M 4/587

(57) ABSTRACT

Provided is an electrolyte for lithium secondary batteries, including a lithium salt, an organic solvent, and an additive including a compound represented by Formula 1.

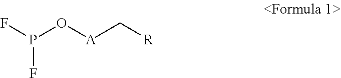

### TECHNICAL FIELD

One or more embodiments relate to an electrolyte for lithium secondary batteries, and a lithium secondary battery including the same.

### BACKGROUND ART

Lithium batteries are used as power sources for portable electronic devices such as video cameras, mobile phones, laptops, or the like. For example, a rechargeable lithium secondary battery is capable of high-speed charging and has an energy density per unit weight that is more than three times the energy density per unit weight of existing lead storage batteries, nickel-cadmium batteries, nickel hydrogen batteries, and nickel-zinc batteries.

Since lithium batteries operate at a high driving voltage, aqueous electrolytes which are highly reactive with lithium cannot be used. In general, lithium batteries use organic electrolytes. Organic electrolytes may be prepared by dissolving a lithium salt in an organic solvent. Preferred organic solvents are those organic solvents which are stable at high voltage and may have high ionic conductivity, high permittivity, and low viscosity.

When an organic electrolyte including a lithium salt is used in a lithium battery, due to side reactions of the electrolyte with the negative electrode/positive electrode, lifetime characteristics and high-temperature stability of the lithium battery may be deteriorated.

Therefore, there is the need for an organic electrolyte which imparts improved lifetime characteristics and high-temperature stability to a lithium battery.

### DESCRIPTION OF EMBODIMENTS

### Technical Problem

One aspect provides a novel additive for lithium secondary batteries.

Another aspect provides an electrolyte for lithium secondary batteries, the electrolyte including the additive.

Another aspect provides a lithium secondary battery including the electrolyte for lithium secondary batteries.

### Solution to Problem

According to an aspect of the present invention,

there is provided an additive for an electrolyte of a lithium secondary battery, comprising a compound represented by Formula 1:

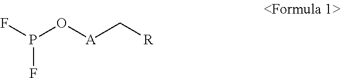

wherein, in Formula 1,

A is a substituted or unsubstituted aliphatic hydrocarbon or (—C₂H₄—O—C₂H₄-)ₙ;

n is an integer selected from 1 to 10; and

R is —CN, —N═C═O, —N═C═S, —OSO₂CH₃, —OSO₂C₂H₅—OSO₂F, or —OSO₂CF₃.

According to another aspect of the present invention, an electrolyte for a lithium secondary battery comprises;

a lithium salt;

a non-aqueous organic solvent; and

the above-described additive.

According to another aspect of the present invention, a lithium secondary battery comprises:

a positive electrode;

a negative electrode; and

the above-described electrolyte for a lithium secondary battery.

### Advantageous Effects of Disclosure

According to one or more aspects, by using an electrolyte for lithium secondary batteries, including an additive containing a phosphine-based compound having a novel structure, a lithium secondary battery may have improved lifetime characteristics and high-temperature stability.

### BRIEF DESCRIPTION OF DRAWINGS

FIG. 1 is a graph illustrating the evaluation results of cyclic voltammetry (CV) characteristics of a negative electrode half cell manufactured according to Example 1.

FIG. 2 is a graph illustrating the evaluation results of CV characteristics of a negative electrode half cell manufactured according to Comparative Example 1.

FIG. 3 is a graph illustrating the evaluation results of electrochemical stability with respect to copper (Cu) dissolution in electrolytes prepared according to Preparation Examples 1 to 3, 5 and 6.

FIG. 4 is a graph illustrating the evaluation results of lifespan characteristics at low temperature (0° C.) of lithium secondary batteries manufactured according to Examples 2 and 3 and Comparative Examples 2 and 3.

FIG. 5 is a schematic view illustrating a lithium battery according to an example embodiment.

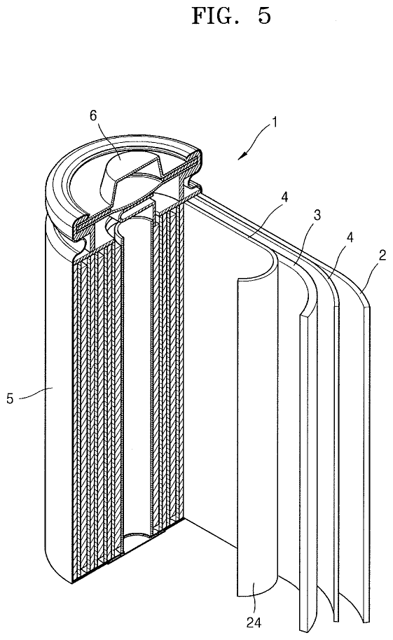

### EXPLANATION OF REFERENCE NUMERALS DESIGNATING THE MAJOR ELEMENTS OF THE DRAWINGS

| | |
|---|---|
| 1: Lithium battery | 2: Negative electrode |
| 3: Positive electrode | 4: Separator |
| 5: Battery case | 6: Cap assembly |

### BEST MODE

Hereinafter, example embodiments of an additive for lithium battery electrolytes, an non-aqueous electrolyte including the same, and a lithium battery using the electrolyte will be described in greater detail.

As used herein, the term “hydrocarbon” means an organic compound consisting of carbons and hydrogen. For example, a hydrocarbon may include a single bond, a double bond, a triple bond, or a combination thereof.

In the expression “Cₐ-C_{b}” used herein, “a” and “b” are integers referring to the number of carbon atoms in a particular group. That is, the group may contain from “a” to “b”, inclusive, carbon atoms. For example, a “C₁-C₄ alkyl group” refers to an alkyl group containing from 1 to 4 carbon atoms, for example, CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

It is to be understood that certain radical naming conventions may include either a mono-radical or a di-radical, depending on the context. For example, when a substituent requires two points of attachment to the rest of the molecule, it is understood that the substituent is a di-radical. For example, a substituent identified as an alkyl group that requires two points of attachment includes di-radicals, such as —CH₂—, —CH₂CH₂—, and —CH₂CH(CH₃)CH₂—. Other radical naming conventions clearly indicate that the radical is a di-radical, such as “alkylene” or “alkenylene.”

The term “alkyl group” or “alkylene group” used herein refers to a branched or non-branched aliphatic hydrocarbon group. In an exemplary embodiment, the alkyl group may be substituted or may not be substituted with a substituent. Examples of the alkyl group are a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl group, and the like, but are not limited thereto. Each of the examples of the alkyl group may be optionally substituted or not substituted with a substituent. In an exemplary embodiment, the alkyl group may have 1 to 6 carbon atoms. Examples of the C₁-C₆ alkyl group are methyl, ethyl, propyl, isopropyl, butyl, isobutyl, sec-butyl, pentyl, 3-pentyl, hexyl, and the like, but are not limited thereto.

The term “alkenyl group” or “alkenylene group” used herein refers to a hydrocarbon having 2 to 20 carbon atoms and at least one carbon-carbon double bond. Examples of the alkenyl group are an ethenyl group, a 1-prophenyl group, a 2-prophenyl group, a 2-methyl-1-prophenyl group, a 1-butenyl group, a 2-butenyl group, a cycloprophenyl group, a cyclopentenyl group, a cyclohexenyl group, a cycloheptenyl group, and the like, but are not limited thereto. In an embodiment, the alkenyl group may be substituted or may not be substituted with a substituent. In an embodiment, the alkenyl group may have 2 to 40 carbon atoms.

The term “alkynyl group” or “alkynylene group” used herein refers to a hydrocarbon having 2 to 20 carbon atoms and including at least one carbon-carbon triple bond. Examples of the alkynyl group are an ethinyl group, a 1-propynyl group, a 1-butynyl group, a 2-butynyl group, and the like, but are not limited thereto. In an embodiment, the alkynyl group may be substituted or may not be substituted with a substituent. In an embodiment, the alkynyl group may have 2 to 40 carbon atoms.

In the present specification, a substituted group is derived from an unsubstituted parent group in which at least one hydrogen is substituted with another atom or group. Unless otherwise indicated, when a group is deemed to be “substituted”, it is meant that the group is substituted with at least one substituent selected from the group consisting of a C₁-C₂₀ alkyl group, a C₂-C₂₀ alkenyl group, a C₂-C₂₀ alkynyl group, a C₁-C₂₀ alkoxy group, a halogen, a cyano group, a hydroxyl group, and a nitro group. In the case where a group is described as being “optionally substituted”, it is meant that the group may be substituted with the above-listed substituents.

According to an embodiment, an additive for lithium secondary battery electrolytes includes a compound represented by Formula 1:

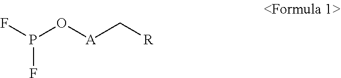

wherein, in Formula 1,

A may be a substituted or unsubstituted aliphatic hydrocarbon or (—C₂H₄—O—C₂H₄—)ₙ;

n may be an integer selected from 1 to 10; and

R may be —CN, —N═C═O, —N═C═S, —OSO₂CH₃, —OSO₂C₂H₅, —OSO₂F, or —OSO₂CF₃.

When the additive including the compound of Formula 1 is added to an electrolyte of a lithium secondary battery, the lithium secondary battery may have improved lifetime characteristics and high-temperature stability.

In one embodiment, in Formula 1, A may be C₁-C₂₀ aliphatic hydrocarbon, or (—C₂H₄—O—C₂H₄—)ₙ; and n may be an integer selected from 1 to 5.

For example, in Formula 1, A may be a C₁-C₂₀ alkylene, a C₂-C₂₀ alkenylene, or a C₂-C₂₀ alkynylene group.

For example, in Formula 1, A may be a methylene group, an ethylene group, a propylene group, a butylene group, or an ethenylene group. For example, in Formula 1, A may be a methylene group.

In one embodiment, in Formula 1, R may be —CN.

In one embodiment, the compound of Formula 1 may be represented by Formula 1-1:

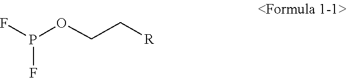

In Formula 1-1, R may be defined as described above.

The compound represented by Formula 1 may be compound 1.

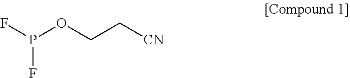

The reason for improving the performance of a lithium secondary battery by the compound being added to an electrolyte will now be described in greater detail, but this is to help understanding of the present invention, not to limit the scope of the invention.

The compound represented by Formula 1 comprises a difluorophosphate (—PF₂) group having excellent electrochemical reactivity for a terminal group, thereby inhibiting the decomposition of an organic solvent such as ethylene carbonate (EC) to reduce generation of gas, and consequentially may reduce a resistance increase rate.

In general, LiPF₆ is used as a lithium salt added to an electrolyte, but has drawbacks such as insufficient thermal stability and easily being hydrolyzed by moisture. However, when an additive including the compound represented by Formula 1 is added to an electrolyte, a phosphorofluoridite (—OPF₂) group, which is a functional group in Formula 1, coordinates water molecules (H₂O) to thereby inhibit the hydrolysis reaction of LiPF₆ by water. As a result, gas generation in the lithium secondary battery is inhibited, thus improving cycle lifetime characteristics. In addition, due to the inhibited generation of gas, swelling of the battery is prevented.

In addition, the difluorophosphate at the terminal site of the compound of Formula 1 forms a stable thin film on a surface of a substrate through complexation reaction with metal ions, for example, copper ions (Cu²⁺), dissolved from the metal substrate. Due to the formation of the thin film, additional dissolution of metal from the substrate is inhibited, and as a result, over-discharge is inhibited when the battery is left alone, and thus battery characteristics is improved.

During initial charging of a lithium secondary battery, decomposition reaction of an electrolyte occurs on the surface of the negative electrode, because of a relatively higher reduction potential of the electrolyte to that of lithium. Such decomposition reaction of the electrolyte lead to a formation of a solid electrolyte interphase (SEI) film on the electrode surface to thereby inhibit migration of electrons for the reaction between the negative electrode and the electrolyte, and consequently prevent further decomposition of the electrolyte. Accordingly, the performance of the battery is dependent largely on the characteristics of the film formed on the negative electrode surface. In consideration of this, there is a need to form a SEI film having more stable and excellent electric characteristics by introducing an additive for the electrolyte, which is decomposed earlier than the electrolyte.

The additive for lithium secondary battery electrolytes, the additive being represented by Formula 1, according to one or more embodiments, may include, at one terminal thereof, a difluorophosphate group having excellent electrochemical reactivity during charging reaction, and thus decomposed prior to the electrolyte, thereby forming, on the negative electrode surface, a SEI film which is stable and has excellent electrical characteristics.

The electrolyte for lithium secondary battery electrolytes, the electrolyte being represented by Formula 1, according to one or more embodiments, may include, at the other terminal thereof, a cyano group (—CN), and thus may form a SEI film having a high concentration of cyano ions and being chemically stable with high polarity. Accordingly, resistance at the interface between the electrolyte and the negative electrode may be reduced, and lithium ion conductivity may be improved, thus leading to increase in low-temperature discharge voltage.

Since the difluorophosphate (—PF₂) group has excellent electrochemical reactivity, the difluorophosphate (—PF₂) group may form a donor-acceptor bond with a transition metal oxide exposed to the surface of a positive active material, thus forming a protective layer in composite form.

In addition, the difluorophosphate (—PF₂) bonded to the transition metal oxide during initial charging of the lithium secondary battery may be oxidized to a plurality of fluorophosphates, thus forming, on the positive electrode, a more stable inactive layer having excellent ion conductivity. Accordingly, it is possible to prevent oxidative decomposition of the other components of the electrolyte, consequentially improving the cycle lifespan of the lithium secondary battery, and at the same time preventing swelling of the battery.

According to an embodiment, an electrolyte for lithium secondary batteries includes: a lithium salt; a non-aqueous organic solvent; and the additive according to any of the above-described embodiments.

For example, the amount of the additive may be in the range of 0.1 wt % to 10 wt % based on a total weight of the electrolyte for lithium secondary batteries, but is not limited thereto, and the amount of the additive may be appropriately selected within the range which does not impart battery characteristics. For example, the amount of the additive may be in the range of 0.1 wt % to 5 wt % based on a total weight of the electrolyte for lithium secondary batteries.

In one embodiment, the electrolyte for lithium secondary batteries may further include an aliphatic nitrile compound. For example, the aliphatic nitrile compound may include acetonitrile (AN) or succinonitrile (SN), but is not limited thereto, and any compound including a nitrile group at a terminal site of the hydrocarbon may be used.

For example, the amount of the aliphatic nitrile compound may be in the range of 0.1 wt % to 10 wt % base on a total weight of the electrolyte for lithium secondary batteries, but is not limited thereto, and any amount of the aliphatic nitrile compound may be appropriately selected within the range which does not impart a metal dissolution inhibitory effect.

In one embodiment, the lithium salt may include at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20, and 2≤y≤20), LiCl, LiI, lithium bis(oxalato)borate (LiBOB), and LiPO₂F₂, but is not limited thereto, and any material available as a lithium salt in the art may be used.

The concentration of the lithium salt in the electrolyte may be 0.01 M to 2.0 M, but is not limited to this range, and may be appropriately adjusted, as necessary. When the concentration of the lithium salt is within this range, further improved battery characteristics may be obtained.

In one embodiment, the organic solvent may include at least one selected from the group consisting of ethylmethyl carbonate (EMC), methylpropyl carbonate, ethylpropyl carbonate, dimethyl carbonate (DMC), diethyl carbonate (DEC), dipropyl carbonate, propylene carbonate (PC), ethylene carbonate (EC), fluoroethylene carbonate (FEC), vinylene carbonate (VC), vinylethylene carbonate (VEC), butylene carbonate, ethyl propionate, ethyl butyrate, dimethyl sulfoxide, dimethyl formamide, dimethyl acetamide, gamma-valerolactone, gamma-butyrolactone, and tetrahydrofuran, but is not limited thereto. Any organic solvent available in the art may be used.

The electrolyte may be in a liquid or gel state. The electrolyte may be prepared by adding, to an organic solvent as described above, a lithium salt and the additive according to any of the above-described embodiments.

According to an embodiment, a lithium secondary battery includes a positive electrode, a negative electrode, and the electrolyte according to any of the above-described embodiments. The lithium secondary battery may have any shape, not limited to a specific shape, including a lithium secondary battery such as a lithium ion battery, a lithium ion polymer battery, or a lithium sulfur battery, and a lithium primary battery.

For example, the negative electrode of the lithium secondary battery may include graphite. The lithium secondary battery may have a high operating voltage of 4.8V or greater.

For example, the lithium battery may be manufactured according to the following method.

First, a positive electrode may be prepared as follows.

For example, a positive active material, a conducting agent, a binder, and a solvent may be mixed to prepare a positive active material composition. The positive active material composition may be directly coated on a metallic current collector to prepare a positive electrode plate. Alternatively, the positive active material composition may be cast on a separate support to form a film, which may then be separated from the support and laminated on a metallic current collector to prepare a positive electrode plate. The positive electrode is not limited to the examples described above, and may be any one of a variety of types.

The positive active material may be any material available in the art, and for example, may be a lithium-containing metal oxide. For example, the positive active material may be at least one of a composite oxide of lithium with a metal selected from cobalt, manganese, nickel, and a combination thereof. Specifically, the positive active material may be a compound represented by one of the following formulae: LiₐA_{1-b}B¹_{b}D¹₂ (wherein 0.90≤a≤1.8, and 0≤b≤0.5); LiₐE_{1-b}B¹_{b}O_{2-c}D¹_{c} (wherein 0.90≤a≤1.8, 0≤b≤0.5, and 0≤c≤0.05); LiE_{2-b}B¹_{b}O_{4-c}D¹_{c} (wherein 0≤b≤0.5 and 0≤c≤0.05); LiₐNi_{1-b-c}Co_{b}B¹_{c}D¹_{α} (wherein 0.90≤a≤1.8, 0≤b≤0.5, 0≤c≤0.05, and 0≤α≤2); LiₐNi_{1-b-c}Co_{b}B¹_{c}O_{2-α}F¹_{α} (wherein 0.90≤a≤1.8, 0≤b≤0.5, 0≤c≤0.05, and 0≤α≤2); LiₐNi_{1-b-c}Co_{b}B¹_{c}O_{2-α}F¹₂ (wherein 0.90≤a≤1.8, 0≤b≤0.5, 0≤c≤0.05, and 0≤α≤2); LiₐNi_{1-b-c}Mn_{b}B¹_{c}D_{α} (wherein 0.90≤a≤1.8, 0≤b≤0.5, 0≤c≤0.05, and 0<α<2); LiₐNi_{1-b-c}Mn_{b}B¹_{c}O_{2-α}F¹_{α} (wherein 0.90≤a≤1.8, 0≤b≤0.5, 0≤c≤0.05, and 0<α<2); LiₐNi_{1-b-c}Mn_{b}B¹_{c}O_{2-α}F¹₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae above, A may be nickel (Ni), cobalt (Co), manganese (Mn), or a combination thereof; B¹ may be aluminum (Al), nickel (Ni), cobalt (Co), manganese (Mn), chromium (Cr), iron (Fe), magnesium (Mg), strontium (Sr), vanadium (V), a rare earth element, or a combination thereof; D¹ may be oxygen (O), fluorine (F), sulfur (S), phosphorus (P), or a combinations thereof; E may be cobalt (Co), manganese (Mn), or a combination thereof; F¹ may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q may be titanium (Ti), molybdenum (Mo), manganese (Mn), or a combination thereof; I may be chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof.

For example, the positive active material may be LiCoO₂, LiMnₓO₂ₓ (wherein x=1 or 2), LiNi₁₋ₓMnₓO₂ₓ (wherein 0≤x≤1), LiNi_{1-x-y}CoₓMn_{y}O₂ (wherein 0≤x≤0.5 and 0≤y≤0.5), and LiFePO₄.

The compounds listed above as positive active materials may have a surface coating layer (hereinafter, also referred to as “coating layer”) on a surface, or a mixture of a compound without a coating layer and a compound having a coating layer, the compounds being selected from the compounds listed above, may be used. The coating layer may include at least one compound of a coating element selected from oxide, hydroxide, oxyhydroxide, oxycarbonate, and hydroxycarbonate of the coating element. The compounds for the coating layer may be amorphous or crystalline. The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. The coating layer may be formed using any method that does not adversely affect the physical properties of the positive active material when a compound of the coating element is used. For example, the coating layer may be formed using a spray coating method, or a dipping method. The coating methods may be well understood by one of ordinary skill in the art, and thus a detailed description thereof will be omitted.

The conducting agent may be carbon black or graphite particles. However, embodiments are not limited thereto. Any material available as a conducting agent in the art may be used.

The binder may be, for example, a vinylidene fluoride/hexafluoropropylene copolymer, polyvinylidene fluoride (PVDF), polyacrylonitrile, polymethyl methacrylate, polytetrafluoroethylene or a mixture thereof, or a styrene butadiene rubber-based polymer. However, embodiments are not limited thereto. Any material available as a binder in the art may be used.

The solvent may be, for example, N-methylpyrrolidone, acetone, or water. However, embodiments are not limited thereto. Any solvent available in the art may be used.

The amounts of the positive active material, the conducting agent, the binder, and the solvent may be the same levels generally used in the art for lithium batteries. At least one of the conducting agent, the binder, and the solvent may be omitted according to the use and the structure of the lithium battery.

Next, a negative electrode may be prepared as follows.

For example, the negative active material according to any of the above-described embodiments, a conducting agent, a binder, and a solvent may be mixed to prepare a negative active material composition. The negative active material composition may be directly coated on a metallic current collector to prepare a negative electrode plate. Alternatively, the negative active material composition may be cast on a separate support to form a film, which may then be separated from the support and laminated on a metallic current collector to prepare a negative electrode plate.

The negative active material may be any negative active material available in the art. For example, the negative active material may include at least one selected from the group consisting of lithium metal, a metal alloyable with lithium, a transition metal oxide, a non-transition metal oxide, and a carbonaceous material.

For example, the metal alloyable with lithium may be Si, Sn, Al, Ge, Pb, Bi, Sb, a Si—Y alloy (wherein Y may be an alkali metal, an alkali earth metal, a Group 13 element, a Group 14 element, a transition metal, a rare earth element, or a combination thereof, and is not Si). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the transition metal oxide may be a lithium titanium oxide, a vanadium oxide, or a lithium vanadium oxide.

For example, the non-transition metal oxide may be SnO₂, or SiOₓ (wherein 0<x<2).

For example, the carbonaceous material may be, for example, crystalline carbon, amorphous carbon, or a mixture thereof. The crystalline carbon may be, for example, graphite such as natural graphite or artificial graphite in amorphous, plate-like, flake-like, spherical or fibrous form. The amorphous carbon may be soft carbon (carbon sintered at low temperatures), hard carbon, meso-phase pitch carbides, sintered cokes, or the like.

The conducting agent and the binder in the negative active material composition may be the same as those used in the positive active material composition.

The amounts of the negative active material, the conducting agent, the binder, and the solvent may be the same levels generally used in the art for lithium batteries. At least one of the conducting agent, the binder, and the solvent may be omitted according to the use and the structure of the lithium battery.

Next, a separator to be disposed between the positive electrode and the negative electrode is prepared.

The separator for the lithium battery may be any separator that is commonly used in lithium batteries. In one embodiment, the separator may have low resistance to migration of ions in an electrolyte and have an excellent electrolyte-retaining ability. Examples of the separator are glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be used for a lithium ion battery. A separator with a good organic electrolytic solution-retaining ability may be used for a lithium ion polymer battery. For example, the separator may be manufactured in the following manner.

In one embodiment, a polymer resin, a filler, and a solvent may be mixed together to prepare a separator composition. Then, the separator composition may be directly coated on an electrode, and then dried to form the separator. In one or more embodiments, the separator composition may be cast on a support and then dried to form a separator film, which may then be separated from the support and laminated on an electrode to form the separator.

The polymer resin used to manufacture the separator is not specifically limited, and may be any material that is commonly used as a binder for electrode plates. Examples of the polymer resin are a vinylidenefluoride/hexafluoropropylene copolymer, polyvinylidene fluoride (PVDF), polyacrylonitrile, polymethylmethacrylate, and a mixture thereof.

Then, the electrolyte according to any of the above-described embodiments may be prepared.

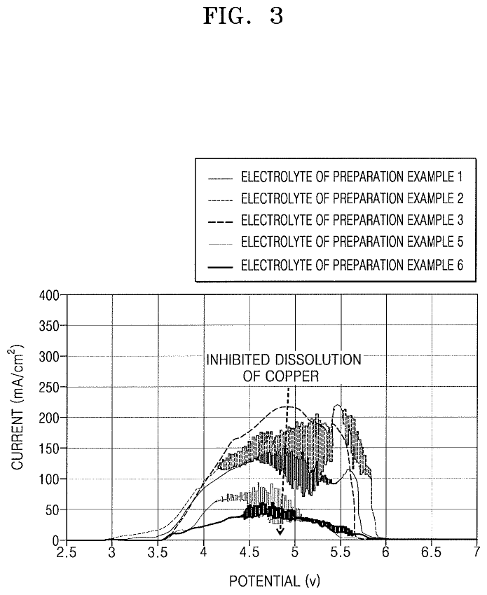

Referring to FIG. 3, a lithium battery 1 according to an embodiment may include a positive electrode 3, a negative electrode 2, and a separator 4. The positive electrode 3, the negative electrode 2, and the separator 4 may be wound or folded, and then sealed in a battery case 5. Then, the battery case 5 may be filled with an organic electrolytic solution and sealed with a cap assembly 6, thereby completing the manufacture of the lithium battery 1. The battery case 5 may be a cylindrical type, a rectangular type, or a thin-film type. In one embodiment, the lithium battery may be a large-size, thin-film type battery. In one or more embodiments, the lithium battery may be a lithium ion battery.

In one embodiment, the separator may be disposed between the positive electrode and the negative electrode to form a battery assembly. In one or more embodiments, the battery assembly may be stacked in a bi-cell structure and impregnated with the electrolytic solution. The resultant assembly may be put into a pouch and hermetically sealed, thereby completing the manufacture of a lithium ion polymer battery.

In addition, a plurality of battery assemblies may be stacked to form a battery pack, which may be used in any device that requires high capacity and high output, for example, in a laptop computer, a smart phone, or an electric vehicle.

In addition, the lithium battery may have improved lifetime characteristics and high rate characteristics, and thus may be used in an electric vehicle (EV), for example, in a hybrid vehicle such as a plug-in hybrid electric vehicle (PHEV). The lithium battery may be applicable to the high-power storage field. For example, the lithium battery may be used in an electric bicycle or a power tool.

One or more embodiments of the present disclosure will now be described in detail with reference to the following examples. However, these examples are only for illustrative purposes and are not intended to limit the scope of the one or more embodiments of the present disclosure.

### MODE OF DISCLOSURE

(Preparation of Electrolyte)

### Preparation Example 1

1.5 M LiPF₆ was added to a first mixed solution of ethylene carbonate (EC), ethylmethyl carbonate (EMC) and dimethyl carbonate (DMC) in a volume ratio of 2:2:6 to prepare a second mixed solution.

0.5 wt % of compound 1 with respect to the weight of the second mixed solution was added to prepare an electrolyte for a lithium secondary battery.

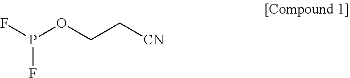

### Preparation Example 2

An electrolyte for a lithium secondary battery was prepared in the same manner as in Preparation Example 1, except that 1 wt % of compound 1 was added.

### Preparation Example 3

An electrolyte for a lithium secondary battery was prepared in the same manner as in Preparation Example 1, except that compound 1 was not added.

### Preparation Example 4

An electrolyte for a lithium secondary battery was prepared in the same manner as in Preparation Example 1, except that 1 wt % of Compound 2 was added instead of compound 1.

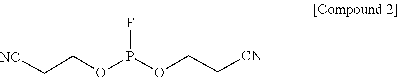 [SMILES: N#CCCOP(F)OCCC#N]

### Preparation Example 5

An electrolyte for a lithium secondary battery was prepared in the same manner as in Preparation Example 1, except that 1 wt % of succinonitrile was further added to the electrolyte prepared in Preparation Example 1.

### Preparation Example 6

An electrolyte for a lithium secondary battery was prepared in the same manner as in Preparation Example 1, except that 1 wt % of succinonitrile was further added to the electrolyte prepared in Preparation Example 2.

### Preparation Example 7

1.5 M LiPF₆ was added to a first mixed solution of ethylene carbonate (EC), fluoroethylene carbonate (FEC), dimethyl carbonate (DMC) in a volume ratio of 2:2:6 to prepare a second mixed solution.

0.2 wt % of LiBF₄, 1 wt % of LiBOB, 1.5 wt % of LiPO₂F₂, 1 wt % of succinonitrile, and 0.5 wt % of compound 1, each with respect to the weight of the second mixed solution, were added to prepare an electrolyte for a lithium secondary battery.

### Preparation Example 8

An electrolyte for a lithium secondary battery was prepared in the same manner as in Preparation Example 7, except that 1 wt % of compound 1 was added.

### Preparation Example 9

An electrolyte for a lithium secondary battery was prepared in the same manner as in Preparation Example 7, except that compound 1 was not added.

### Preparation Example 10

An electrolyte for a lithium secondary battery was prepared in the same manner as in Preparation Example 7, except that 1 wt % of Compound 2 was added instead of compound 1.

(Manufacture of Negative Electrode Half Cell)

### Example 1

A negative electrode including graphite, and a lithium foil as a counter electrode were used. A separator was disposed between the negative electrode and the counter electrode, and electrolyte was injected to thereby manufacture a negative electrode half cell.

The separator used was a porous polyethylene membrane.

The electrolyte used was the electrolyte prepared in Preparation Example 3.

### Comparative Example 1

A negative electrode half cell was manufactured in the same manner as in Example 1, except that the electrolyte prepared in Preparation Example 1 was used instead of the electrolyte prepared in Preparation Example 3.

### Evaluation Example 1: Evaluation of Cyclic Voltammetry (CV) Characteristics of Negative Electrode Half Cell

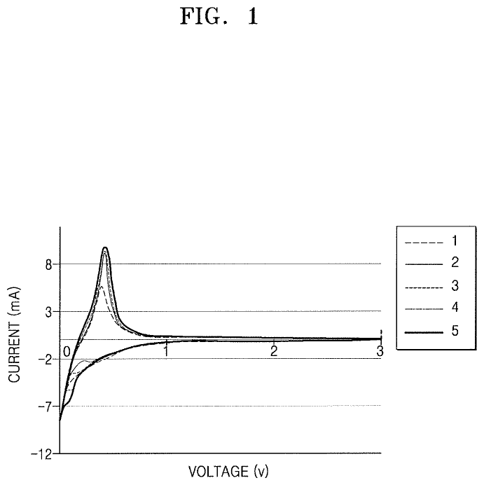

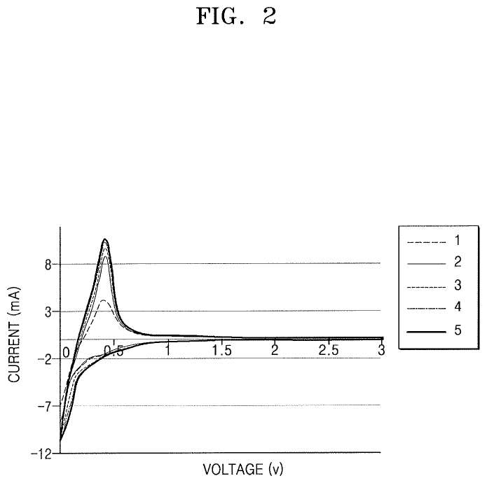

Cyclic voltammetry (CV) characteristics were evaluated using the negative electrode half cells manufactured in Example 1 and Comparative Example 1. The results of the negative electrode half cells of Example 1 and Comparative Example 1 are shown in FIGS. 1 and 2, respectively. In FIGS. 1 and 2, the numbers 1, 2, 3, 4, and 5 indicate the number of cycles.

Referring to FIGS. 1 and 2, there were found an increase in current value near 0.5V at the 1^{st} cycle, and nearly no significant change in current value as the cycle progressed. Accordingly, it was found that compound 1 was oxidized in the electrolyte, nearly not decomposing the negative active material, and thus had excellent compatibility with the negative electrode.

### Evaluation Example 2: Linear Sweep Voltammetry (LSV) Test for Cu-Dissolution Inhibitory Effect

A linear sweep voltammetry (LSV) test was performed at room temperature using a copper (Cu) electrode, a lithium electrode as a counter electrode, and each of the electrolytes prepared in Preparation Examples 1 to 3, 5, and 6. The test results are shown in FIG. 3.

Referring to FIG. 3, it was found that Cu dissolution started at between 3V to 3.5V with a sharp current increase. In addition, those electrolytes including compound 1 were found to have suppressed increase in current despite the dissolution of Cu, and to exhibit further effectively inhibited dissolution of Cu when succinonitrile was further included.

(Manufacture of Lithium Secondary Battery)

### Example 2

(Manufacture of Negative Electrode)

After 98 wt % of artificial graphite (BSG-L, available from Tianjin BTR New Energy Technology Co., Ltd.). 1.0 wt % of styrene-butadiene rubber (SBR) binder (available from ZEON), and 1.0 wt % of carboxymethyl cellulose (CMC, available from NIPPON A&L) were mixed together, and distilled water was added thereto and then stirred with a mechanical stirrer for 60 minutes to prepare a negative active material slurry. The slurry was applied onto a copper current collector having a thickness of 10 μm using a doctor blade to a thickness of about 60 μm, dried in a hot-air dryer at 100° C. for 0.5 hours, dried again at 120° C. under vacuum for 4 hours, and then roll-pressed to manufacture a negative electrode plate.

(Manufacture of Positive Electrode)

97.45 wt % of LiNi_{0.33}Co_{0.33}Mn_{0.33}O₂, 0.5 wt % of artificial graphite powder (SFG6, Timcal) as a conducting agent, 0.7 wt % of carbon black (Ketjenblack, ECP), 0.25 wt % of modified acrylonitrile rubber (BM-720H, Zeon Corporation), 0.9 wt % of polyvinylidene fluoride (PVdF, S6020, Solvay), and 0.2 wt % of polyvinylidene fluoride (PVdF, S5130, Solvay) were mixed, added to a N-methyl-2-pyrrolidone solvent, and stirred using a mechanical stirrer for 30 minutes to prepare a positive active material slurry. The slurry was applied onto an aluminum current collector having a thickness of 20 μm using a doctor blade to a thickness of about 60 μm, dried in a hot-air dryer at 100° C. for 0.5 hours, dried again at 120° C. under vacuum for 4 hours, and then roll-pressed to manufacture a positive electrode plate.

A 14 μm-thick polyethylene separator with a ceramic coating on a positive electrode side thereof, and the electrolyte prepared in Preparation Example 7 were used to manufacture a lithium secondary battery.

### Example 3

A lithium secondary battery was manufactured in the same manner as in Example 2, except that the electrolyte prepared in Preparation Example 8 was used instead of the electrolyte prepared in Preparation Example 7.

### Comparative Example 2

A lithium secondary battery was manufactured in the same manner as in Example 2, except that the electrolyte prepared in Preparation Example 9 was used instead of the electrolyte prepared in Preparation Example 7.

### Comparative Example 3

A lithium secondary battery was manufactured in the same manner as in Example 2, except that the electrolyte prepared in Preparation Example 10 was used instead of the electrolyte prepared in Preparation Example 7.

### Evaluation Example 3: Test of Gas Generation Inhibition Under High-Temperature Storage

After the lithium secondary batteries manufactured in Examples 2 and 3 and Comparative Examples 2 and 3 were left at high temperature (90° C.), the time it took for a current interrupt device (CID) to become short. The results are shown in Table 1.

TABLE 1

| | CID open time (hr) |
|---|---|
| Example 2 | 35.9 |
| Example 3 | 47.1 |
| Comparative | 23.1 |
| Example 2 | |
| Comparative | 25.3 |
| Example 3 | |

### Evaluation Example 4: Evaluation of Low-Temperature (0° C.) Lifespan

The lithium secondary batteries manufactured in Examples 2 and 3 and Comparative Examples 2 and 3 were each charged at 0° C. with a constant current of 0.1 C rate until a voltage of 4.2V (with respect to Li) was reached, and then with a constant voltage of 4.2V (constant voltage mode) with a cutoff current of 0.05 C rate. Subsequently, each lithium secondary battery was discharged with a constant current of 0.1 C rate until a voltage of 2.5 V (with respect to Li) was reached (formation process, 1^{st} cycle).

Each of the lithium secondary batteries after the 1^{st} cycle of the formation process was charged at 0° C. with a constant current of 0.2 C rate until a voltage of 4.2 V (with respect to Li) was reached, and then with a constant voltage of 4.2V (constant voltage mode) with a cut-off current of 0.05 C rate. Subsequently, each lithium secondary battery was discharged with a constant current of 0.1 C rate until a voltage of 2.5V (with respect to Li) was reached (formation process, 2^{nd} cycle).

Each of the lithium secondary batteries after the 2^{nd} cycle of formation process was charged at 0° C. with a constant current of 0.5 C rate until a voltage of 4.2V (with respect to Li) was reached, and then with a constant voltage of 4.2 V (constant voltage mode) with a cut-off current of 0.05 C rate. Subsequently, each lithium secondary battery was discharged with a constant current of 1.0 C rate until a voltage of 2.5V (with respect to Li) was reached (formation process, 3^{rd} cycle).

After the formation process above, each of the lithium secondary batteries was charged at 0° C. with a constant current of 1.0 C rate until a voltage of 4.2V (with respect to Li) was reached, and then with a constant voltage of 4.2 V (constant voltage mode) with a cut-off current of 0.05 C rate. Subsequently, each lithium secondary battery was discharged with a constant current of 1.0 C rate until a voltage of 2.5V (with respect to Li) was reached. This charge and discharge cycle was repeated to the 80^{th} cycle.

Throughout the entire charge and discharge cycles, a rest time for 30 minutes was allowed after each charge and discharge cycle.

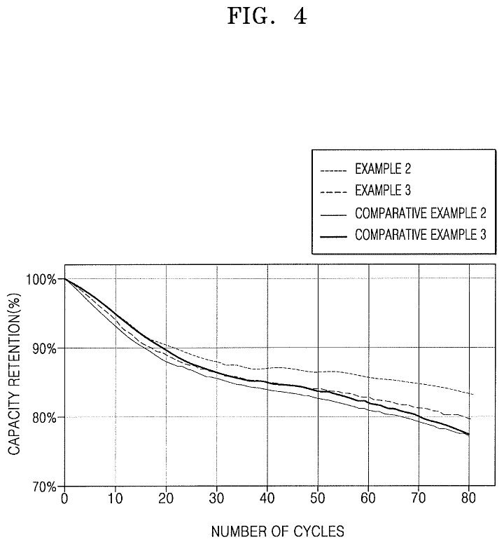

The results of the charge and discharge test are shown in Table 2 and FIG. 4.

TABLE 2

| | Capacity retention at |
|---|---|
| | 80^{th} cycle (%) |
| Example 2 | 83.2 |
| Example 3 | 80.0 |
| Comparative | 78.7 |
| Example 2 | |
| Comparative | 78.2 |
| Example 3 | |

Referring to FIG. 2, the lithium secondary batteries of Examples 2 and 3 were found to have a higher capacity retention under the same conditions, as compared with the lithium secondary batteries of Comparative Examples 2 and 3, not including compound 1.

### Evaluation Example 5: Resistance Test Under High-Temperature Storage (60° C., 28 Days)

While the lithium secondary batteries manufactured in Examples 2 and 3, and Comparative Examples 2 and 3 were stored at a high temperature (60° C.), the resistance thereof was measured on the first day (0 day) of storage and on 28^{th} day after the storage to calculate a resistance increase rate (%). The results are shown in Table 3.

TABLE 3

| | High-temperature resistance |
|---|---|
| | increase rate (%) |
| Example 2 | 120.6 |
| Example 3 | 118.6 |
| Comparative | 129.5 |
| Example 2 | |
| Comparative | 125.4 |
| Example 3 | |

Referring to Table 3, the lithium secondary batteries of Examples 2 and 3 were found to have a significantly lower high-temperature resistance increase ratio even after long-term storage at high temperature, as compared with the lithium secondary batteries of Comparative Examples 2 and 3, not including compound 1. This is thought to be since side reactions of LiPF₆ were effectively inhibited by —OPF₂ functional group of compound 1.

### Evaluation Example 6: Test of Initial Discharge Voltage Drop after Low-Temperature Storage (−20° C. for 2 h)

After the lithium secondary batteries manufactured in Examples 2 and 3, and Comparative Examples 2 and 3 were stored at a low temperature (−20° C.) for 2 hours, an initial discharge voltage drop was measured. The results are shown in Table 4.

TABLE 4

| | Initial discharge |
|---|---|
| | voltage drop (V) |
| Example 2 | 2.270 |
| Example 3 | 2.290 |
| Comparative | 2.249 |
| Example 2 | |
| Comparative | 2.250 |
| Example 3 | |

Referring to Table 4, the lithium secondary batteries of Examples 2 and 3 were found to have an increase in initial discharge voltage drop even after long-term storage at low temperature, as compared with the lithium secondary batteries of Comparative Examples 2 and 3, not including compound 1. This is thought to be since —CN group of compound 1 formed a polar solid electrolyte interface (SEI) film on the surface of the negative electrode, leading to reduction in resistance at the negative electrode interface.

1. An additive for an electrolyte of a lithium secondary battery, comprising a compound represented by Formula 1: 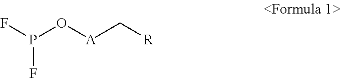
wherein, in Formula 1,
A is a substituted or unsubstituted aliphatic hydrocarbon, or (—C₂H₄—O—C₂H₄-)ₙ;
n is an integer selected from 1 to 10; and
R is —CN, —N═C═O, —N═C═S, —OSO₂CH₃, —OSO₂C₂H₅, —OSO₂F, or —OSO₂CF₃.

2. The additive of claim 1, wherein A in Formula 1 is a C₁-C₂₀ aliphatic hydrocarbon, or (—C₂H₄—O—C₂H₄-)ₙ; and
n is an integer selected from 1 to 5.

3. The additive of claim 1, wherein A in Formula 1 is a C₁-C₂₀ alkylene, a C₂-C₂₀ alkenylene, or a C₂-C₂₀ alkynylene group.

4. The additive of claim 1, wherein A in Formula 1 is a methylene group, an ethylene group, a propylene group, a butylene group, or an ethenylene group.

5. The additive of claim 1, wherein the compound is represented by Formula 1-1: 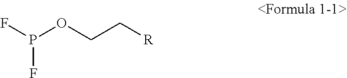
wherein, Formula 1-1, R is —CN, —N═C═O, —N═C═S, —OSO₂CH₃, —OSO₂C₂H₅, —OSO₂F, or —OSO₂CF₃.

6. An electrolyte for a lithium secondary battery, comprising:
a lithium salt;
a non-aqueous organic solvent; and
the additive according to claim 1.

7. The electrolyte of claim 6, wherein an amount of the additive is in the range of 0.1 wt % to 10 wt % based on a total weight of the electrolyte for a lithium secondary battery.

8. The electrolyte of claim 6, further comprising an aliphatic nitrile compound.

9. The electrolyte of claim 8, wherein an amount of the aliphatic nitrile compound is in the range of 0.1 wt % to 10 wt % based on a total weight of the electrolyte for a lithium secondary battery.

10. The electrolyte of claim 6, wherein the lithium salt comprises at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), and LiPO₂F₂.

11. The electrolyte of claim 6, wherein the organic solvent comprises at least one selected from the group consisting of ethylmethyl carbonate (EMC), methylpropyl carbonate, ethylpropyl carbonate, dimethyl carbonate (DMC), diethyl carbonate (DEC), dipropyl carbonate, propylene carbonate (PC), ethylene carbonate (EC), fluoroethylene carbonate (FEC), vinylene carbonate (VC), vinylethylene carbonate (VEC), butylene carbonate, ethyl propionate, ethyl butyrate, dimethyl sulfoxide, dimethyl formamide, dimethyl acetamide, gamma-valerolactone, gamma-butyrolactone, and tetrahydrofuran.

12. A lithium secondary battery comprising:
a positive electrode;
a negative electrode;
the electrolyte for a lithium secondary battery, according to claim 6.

13. The lithium secondary battery of claim 12, wherein the negative electrode comprises graphite.
